(19) United States
(12) Patent Application Publication
(10) Pub. No.: US 2021/0025454 A1
(43) Pub. Date: Jan. 28, 2021

(54) ARRANGEMENT HAVING MACHINE ELEMENTS AND SEALING ARRANGEMENT THEREFOR

(71) Applicant: Schaeffler Technologies AG & Co. KG, Herzogenaurach (DE)

(72) Inventors: Thomas Nogueira da Silva, Piedade (BR); Murilo Cesar Ponce Oliveira, Sorocaba (BR)

(73) Assignee: Schaeffler Technologies AG & Co. KG, Herzogenaurach (DE)

(21) Appl. No.: 17/041,849

(22) PCT Filed: Jan. 17, 2019
(86) PCT No.: PCT/DE2019/100043

§ 371 Date: Sep. 25, 2020

(30) Foreign Application Priority Data
Apr. 4, 2018 (DE) 10 2018 107 873.0

(51) Int. Cl. F16C 33/78; F16C 19/18

(52) U.S. Cl. CPC F16C 33/7823; F16C 19/18

(57) ABSTRACT

A sealing arrangement includes a centrifugal disk and an elastic sealing ring. The centrifugal disc includes an axial expansion for fixing the centrifugal disc to a machine element, and a region extending radially from the axial expansion. The elastic sealing ring includes a first circumferential sealing lip and a second circumferential sealing lip, arranged radially outside of the first circumferential sealing lip. The first circumferential sealing lip has a first circumferential sealing edge, directed radially inward and arranged to lie on the centrifugal disc, and a second circumferential sealing edge, directed axially outward and arranged to lie on the centrifugal disc. The second circumferential sealing lip has a third circumferential sealing edge, directed radially inward and arranged to lie on the centrifugal disc, and a fourth circumferential sealing edge, directed axially outward and arranged to lie on the centrifugal disc.

### CROSS-REFERENCE TO RELATED APPLICATIONS

This application is the United States National Phase of PCT Appln. No. PCT/DE2019/100043 filed Jan. 17, 2019, which claims priority to German Application No. DE102018107873.0 filed Apr. 4, 2018, the entire disclosures of which are incorporated by reference herein.

### TECHNICAL FIELD

The present disclosure relates first to a sealing arrangement for sealing off a space between a first machine element and a second machine element. The first machine element and the second machine element are rotatable relative to each other about an axis of rotation. The sealing arrangement includes a centrifugal disc and an elastic sealing ring, wherein the sealing ring has a first circumferential sealing lip, which includes a first circumferential sealing edge, which is directed radially inward, and a second circumferential sealing edge, which is directed axially outward. The disclosure further relates to an arrangement having a first machine element and having a second machine element, as well as having the sealing arrangement according to the disclosure. The arrangement may be a sealed rolling bearing, which is designed for use in an agricultural vehicle or in an agricultural machine.

### BACKGROUND

DE 10 2011 077 729 A1 describes a rolling bearing seal having an elastomer-based pre-sealing. The sealing arrangement is in particular a cassette seal having a carrier ring having at least one sealing lip and a cover ring. The sealing lip forms a constantly sliding sealing contact on the cover ring. Furthermore, the elastic part arranged on a radially aligned carrier ring part has an axial projection which at least partially covers a radial end piece of the cover ring. The projection partially takes on the sealing function.

DE 10 2010 019 442 A1 discloses a rolling bearing having an integrated seal, which includes an annular sealing disc having elastic properties, which is inserted with a first edge into a retaining groove on one of the bearing rings and engages with a second edge sliding into a sealing groove arrangement on the other bearing ring. To secure the sealing disc against deformation, the sealing disc can be reinforced and stiffened in a region adjoining the first edge, while the remaining region of the sealing ring is still elastic.

DE 10 2009 012 076 A1 describes a sealing arrangement for a rolling bearing having at least one raceway ring having a raceway for the rolling of rolling elements. The sealing arrangement includes a sealing disc, which seals the rolling element space in an axial direction of the sealing arrangement. A puncture region is arranged in the raceway ring, in which the sealing disc is arranged in a self-retaining or self-locking manner. The bearing surface and the raceway overlap at least in sections in the radial direction of the axis of rotation of the rolling bearing. The sealing disc can be designed as a contact seal, which lies on a counter-sealing surface opposite the at least one raceway ring.

DE 10 2008 030 710 A1 describes a cassette seal, which is arranged between two coaxially arranged and rotatable elements of an arrangement and is used to seal an interior space of the arrangement. The cassette seal consists of a sealing disc arranged on the inside in the axial direction and a centrifugal disc arranged on the outside in the axial direction. The centrifugal disc has an L-shaped cross-section. The sealing disc and the centrifugal disc have axial expansions, by means of which they are firmly connected to the respectively assigned element of the arrangement. The sealing disc has at least one sealing lip, which is in contact with the centrifugal disc to seal the interior space.

U.S. Pat. No. 6,817,769 B2 discloses a cassette seal for a rolling bearing, which includes a sealing disc and a centrifugal disc having an L-shaped cross-section. The sealing disc is connected to the outer ring. The centrifugal disc is attached to the inner ring and is arranged in the axial direction in front of the sealing disc. The sealing disc has a radial expansion extending into the rolling element space. At the end of the radial expansion of the sealing disc are arranged three sealing lips made of an elastomer, one of which is in contact with the centrifugal disc in the axial direction and two in the radial direction.

### SUMMARY

The sealing arrangement according to the disclosure serves to seal off a space from an exterior. The sealing arrangement prevents substances such as water, particles and other contaminants from entering the space from the outside. The space spans between a first machine element and a second machine element. The first machine element and the second machine element are rotatable relative to each other about a common axis of rotation. Directions given below, in particular an axial direction, a radial direction and a tangential or circumferential direction, are relative to the axis of rotation. The first machine element may be arranged to lie radially outward, while the second machine element may be arranged to lie radially inward.

The sealing arrangement includes a centrifugal disc arranged on the outside in the axial direction relative to the space to be sealed. The centrifugal disc has an axial expansion via which it can be fixed or fastened to the second machine element. The axial expansion may have the basic shape of a hollow cylinder or a cylinder jacket, which is coaxial to the axis of rotation. The centrifugal disc also has a region that extends radially outward from the axial expansion. The radially extending region may extend radially outward from the axial expansion. The radially extending region forms a centrifugal surface, which may have essentially the basic shape of a circular ring.

The sealing arrangement furthermore includes an elastic sealing ring, which may be arranged on the inside in the axial direction, i.e., directly in front of the space to be sealed. The sealing ring is thus arranged in the axial direction between the space to be sealed and the centrifugal disc. The elastic sealing ring may be designed for tight attachment to the first machine element. The elastic sealing ring may include an elastomer and a first circumferential sealing lip, which includes a first circumferential sealing edge directed radially inward, and a second circumferential sealing edge directed axially outward. The first circumferential sealing edge, which is directed radially inward may lie on the axial expansion of the centrifugal disc or on the second machine element. The first circumferential sealing edge, which is directed radially inward, may lie on the axial expansion of the centrifugal disc or on the second machine element. The second circumferential sealing edge, which is directed axially outward, can lie on the centrifugal disc, e.g., on the radially extending region of the centrifugal disc. The second circumferential sealing edge, which is directed axially outward, may lie on the centrifugal disc, e.g., on the radially extending region of the centrifugal disc.

According to the disclosure, the elastic sealing ring includes a second circumferential sealing lip, which has a third circumferential sealing edge, which is directed radially inward, and a fourth circumferential sealing edge, which is directed axially outward, which can lie on the centrifugal disc. The third circumferential sealing edge, which is directed radially inward. and the fourth circumferential sealing edge, which is directed axially outward may lie on the centrifugal disc, e.g., on the radially extending region of the centrifugal disc.

The sealing arrangement according to the disclosure has at least four circumferential sealing edges, which help prevent contaminants from entering the space to be sealed.

In example embodiments of the sealing arrangement according to the disclosure, the sealing ring furthermore has a circumferential wiper lip, which is directed radially inward and may be arranged in the axial direction in front of the first sealing lip, so that it is arranged directly in front of the space to be sealed. The wiper lip can lie on the second machine element and surround the same circumferentially. This embodiment of the sealing arrangement according to the disclosure has at least five circumferential sealing edges including the wiper lip, which prevent containments from entering the space to be sealed to an even greater extent. The wiper lip is may be arranged to be axially adjacent to the first sealing lip, and lies on the inside relative to the axial direction.

In example embodiments of the sealing arrangement according to the disclosure, the first sealing lip has a circumferential guide ring receptacle, which is arranged in the radial direction over the first circumferential sealing edge, which is directed radially inward. The guide ring receptacle is may be arranged in the axial direction next to the second circumferential sealing edge directed axially outward. The guide ring receptacle may be formed by a circumferential hollow or a circumferential groove. These example embodiments further include a first guide ring, which is seated in the guide ring receptacle of the first sealing lip. The first circumferential sealing edge, which is directed radially inward, is pressed inward in the radial direction by the first guide ring, and the second circumferential sealing edge, which is directed axially outward, is pressed outward in the axial direction by the first guide ring.

In example embodiments of the sealing arrangement according to the disclosure, the second sealing lip has a circumferential guide ring receptacle, which is arranged in the radial direction over the third circumferential sealing edge, which is directed radially inward. The guide ring receptacle may be arranged in the axial direction next to the fourth circumferential sealing edge, which is directed axially outward. The guide ring receptacle may be formed by a circumferential hollow or a circumferential groove. These example embodiments further include a second guide ring, which is seated in the guide ring receptacle of the second sealing lip. The third circumferential sealing edge, which is directed radially inward, is pressed inward in the radial direction by the second guide ring, and the third circumferential sealing edge, which is directed axially outward, is pressed outward in the axial direction by the second guide ring.

The first guide ring and/or the second guide ring may each consist of an elastic material and may each exert a force in the radial direction inward and a force in the axial direction. The first guide ring and the second guide ring each may consist of spring steel.

A cross-section, which lies in a plane including the axis of rotation and intersects the first guide ring, may have a circular ring shape. A cross-section, which lies in a plane including the axis of rotation and intersects the second guide ring, may have a circular ring shape.

The centrifugal disc may have a first L-profile-shaped circumferential section. A cross-section, which lies in a plane including the axis of rotation and intersects the centrifugal disc, accordingly has the first L-profile shape. The first sealing lip can lie in the first L-profile-shaped circumferential section of the centrifugal disc and may lie thereon. The first L-profile-shaped circumferential section of the centrifugal disc may be formed by the axial expansion of the centrifugal disc and by a radially inner circumferential part of the region of the centrifugal disc extending radially outward.

In the region thereof that extends radially outward, the centrifugal disc may have a second L-profile-shaped circumferential section. A cross-section, which lies in a plane encompassing the axis of rotation and intersects the centrifugal disc, accordingly also has the second L-profile shape. The second sealing lip can lie in the second L-profile-shaped circumferential section of the centrifugal disc and may lie thereon. The second L-profile-shaped circumferential section is arranged in the radial direction over the first L-profile-shaped circumferential section. The first L-profile-shaped circumferential section and the second L-profile-shaped circumferential section each have a horizontal leg of the L-profile shape thereof, which is arranged parallel to the axis of rotation or is slightly inclined at an angle of at most 30° to the axis of rotation. The first L-profile-shaped circumferential section and the second L-profile-shaped circumferential section each have a vertical leg of the L-profile shape thereof, which is arranged in the radial direction or is inclined slightly at an angle of at most 30° to the radial direction.

The first circumferential sealing edge, which is directed radially inward, of the first sealing lip, may lie on the horizontal leg of the L-profile shape of the first L-profile-shaped circumferential section of the centrifugal disc. The second circumferential sealing edge, which is directed axially outward, of the first sealing lip, may lie on the vertical leg of the L-profile shape of the first L-profile-shaped circumferential section of the centrifugal disc.

The third circumferential sealing edge, which is directed radially inward, of the second sealing lip may lie on the horizontal leg of the L-profile shape of the second L-profile-shaped circumferential section of the centrifugal disc. The fourth circumferential fourth sealing edge, which is directed axially outward, of the second sealing lip may lie on the vertical leg of the L-profile shape of the second L-profile-shaped circumferential section of the centrifugal disc.

The sealing arrangement may include a reinforcement to which the elastic sealing ring is applied, such that the reinforcement reinforces the elastic sealing ring. The reinforcement may consist of a metal. The reinforcement may have a circular ring shape. The reinforcement may be arranged on the inside in front of the sealing ring in the axial direction. The reinforcement may be designed to be fastened in a circumferential groove, which is directed radially inward, of the first machine element; for example by pressing in. At the radially outer end thereof, the elastic sealing ring may have a circumferential elastic clamping bead, which sits on the reinforcement. The elastic clamping bead clamps the elastic sealing ring with the reinforcement in the circumferential groove, which is directed radially inward, of the first machine element.

The arrangement according to the disclosure includes a first machine element and a second machine element, which are rotatable relative to each other about an axis of rotation. The arrangement according to the disclosure further includes the sealing arrangement according to the disclosure for sealing off a space between the first machine element and the second machine element. The elastic sealing ring is attached to the first machine element. The centrifugal disc is attached to the second machine element. The arrangement according to the disclosure may include one of the described embodiments of the sealing arrangement. In addition, the arrangement according to the disclosure may have features that are described in connection with the sealing arrangement according to the disclosure.

The centrifugal disc may have a circumferential terminating edge at the radially outer end thereof. A circumferential air gap may be formed between the terminating edge and the first machine element, such that a contactless seal is formed. The air gap may have only a small width, such that no larger particles can get through the air gap.

According to an example embodiment of the arrangement according to the disclosure, the first and the second machine element are bearing rings of a rolling bearing, such that the arrangement according to the disclosure forms a sealed rolling bearing. The first machine element may be an outer ring of the rolling bearing. The second machine element may be an inner ring of the rolling bearing. In this embodiment, the space to be sealed is at least partially formed by an interior space serving to accommodate rolling elements. The sealing arrangement may be arranged at an axial end of the rolling bearing. The seal arrangement can also be installed in other types of bearings.

The rolling bearing may be designed for use in an agricultural vehicle or in an agricultural machine. The agricultural machine may be a planting machine or a seeder. Agricultural vehicles or agricultural machines are exposed to dust, particles, dirt, etc., so that the rolling bearing according to the disclosure having the improved sealing effect of the sealing arrangement according to the disclosure is particularly advantageous.

### BRIEF DESCRIPTION OF THE DRAWINGS

Further advantages, details and developments of the present disclosure will become apparent from the following description of an example embodiment, with reference to the accompanying drawings, wherein:

FIG. 1 shows a cross-sectional view of an example embodiment of an arrangement according to the disclosure having a sealing arrangement according to the disclosure;

FIG. 2 shows a detailed view of the arrangement shown in FIG. 1; and

FIG. 3 shows a detailed view of a sealing ring shown in FIG. 1.

### DETAILED DESCRIPTION

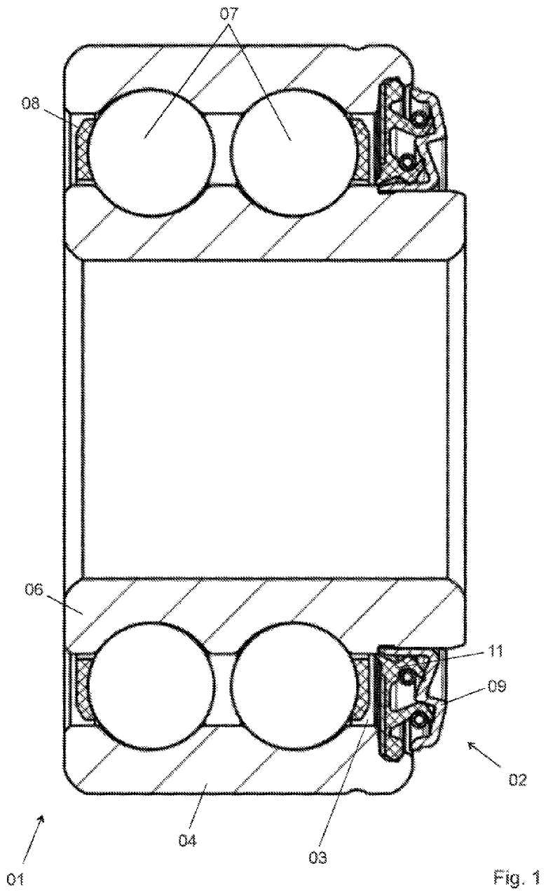

FIG. 1 shows a cross-sectional view of an example embodiment of an arrangement 01 according to the disclosure having a sealing arrangement 02 according to the disclosure. The arrangement is a sealed rolling bearing 01 having a bearing interior 03, which is sealed by the sealing arrangement 02. The rolling bearing 01 includes a bearing outer ring 04 and a bearing inner ring 06, between which rolling elements 07 are arranged in the form of balls, which are guided by a cage 08.

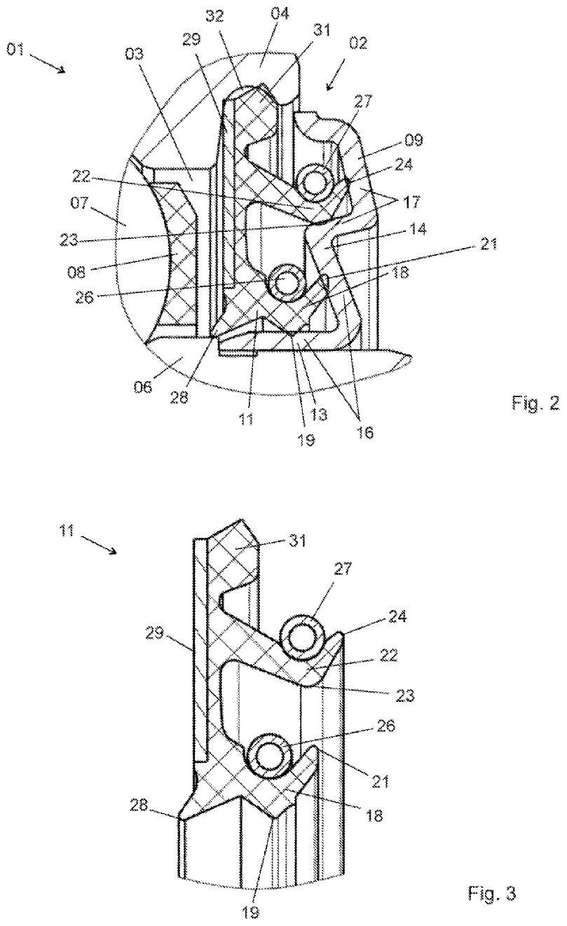

The sealing arrangement 02 includes a centrifugal disc 09, which is seated firmly and tightly on the bearing inner ring 06. The sealing arrangement 02 further includes an elastic sealing ring 11, which sits firmly and tightly in the bearing outer ring 04. The centrifugal disc 09 and the sealing ring 11 are shown in detail in FIG. 2.

FIG. 2 shows a detailed view of the sealed rolling bearing 01 shown in FIG. 1. The centrifugal disc 09 includes an axial expansion 13 with which it sits on the bearing inner ring 06. A circumferentially formed region 14 extends in the radial direction from the axial expansion 13. At the transition from the axial expansion 13 to the region 14 extending in the radial direction, a first L-profile-shaped section 16 of the centrifugal disc 09 is formed. A second L-profile-shaped section 17 is formed in the radial direction over the first L-profile-shaped section 16 of the centrifugal disc 09 in the region 14 of the centrifugal disc 09 extending in the radial direction.

The elastic sealing ring 11 includes a first circumferential sealing lip 18, which has a first circumferential sealing edge 19, which is directed radially inward, and a second circumferential sealing edge 21, which is directed axially outward. The first circumferential sealing edge 19, which is directed radially inward, and the second circumferential sealing edge 21, which is directed axially outward, lie on the centrifugal disc 09 in the first L-profile section 16 thereof.

The elastic sealing ring 11 further includes a second circumferential sealing lip 22, which has a third circumferential sealing edge 23, which is directed radially inward, and a fourth circumferential sealing edge 24, which is directed axially outward. The third circumferential sealing edge 23, which is directed radially inward, and the fourth circumferential sealing edge 24, which is directed axially outward, lie on the centrifugal disc 09 in the second L-profile section 17 thereof.

The first circumferential sealing lip 18 is pressed radially inward and in the axial direction by a first guide ring 26 made of spring steel. The second circumferential sealing lip 22 is pressed radially inward and in the axial direction by a second guide ring 27 made of spring steel.

The elastic sealing ring 11 further includes a circumferential wiper lip 28, which is directed radially inward, which circumferentially lies on the bearing inner ring 06.

The sealing arrangement 02 further includes a reinforcement 29, on which the elastic sealing ring 11 is applied and reinforces same. The reinforcement 29 consists of a metal and has a circular ring shape. The elastic sealing ring 11 has a circumferential elastic clamping bead 31 at the radially outer end thereof. The elastic clamping bead 31 clamps the elastic sealing ring 11 with the reinforcement 29 in a circumferential groove 32 directed radially inward, which is formed in the bearing outer ring 04, as a result of which the elastic sealing ring 11 is fastened in the bearing outer ring 04.

FIG. 3 shows a detailed view of the sealing ring 11 shown in FIG. 1 and in FIG. 2. In particular, the first circumferential sealing lip 18 having the first circumferential sealing edge 19, which is directed radially inward, and the second circumferential sealing edge 21, which is directed axially outward, and the second circumferential sealing lip 22 having the third circumferential third sealing edge 23, which is directed radially inward, and the fourth circumferential sealing edge 24, which is directed axially outward, are shown.

### REFERENCE NUMERALS

01 Rolling bearing

02 Sealing arrangement

03 Bearing interior space

04 Bearing outer ring

05 -

06 Bearing inner ring

07 Rolling elements

08 Cage

09 Centrifugal disc

10 -

11 Sealing ring

12 -

13 Axial expansion

14 Region extending in the radial direction

15 -

16 First L-profile-shaped section

17 Second L-profile-shaped section

18 First circumferential sealing lip

19 First circumferential sealing edge directed radially inward

20 -

21 Second circumferential sealing edge directed axially outward

22 Second circumferential sealing lip

23 Third circumferential sealing edge directed radially inward

24 Fourth circumferential sealing edge directed axially outward

25 -

26 First guide ring

27 Second guide ring

28 Circumferential wiper lip

29 Reinforcement

30 -

31 Clamping bead

32 Groove

1-10. (canceled)

11. A sealing arrangement for sealing off a space between a first machine element and a second machine element, rotatable relative to each other about an axis of rotation, the sealing arrangement comprising:
a centrifugal disc arranged on an axial outside, comprising:
an axial expansion for fixing the centrifugal disc to the second machine element; and
a region extending radially from the axial expansion; and
an elastic sealing ring arranged for fixing on the first machine element, comprising:
a first circumferential sealing lip, comprising:
a first circumferential sealing edge, directed radially inward and arranged to lie on the centrifugal disc; and
a second circumferential sealing edge, directed axially outward and arranged to lie on the centrifugal disc; and
a second circumferential sealing lip is arranged radially outside of the first circumferential sealing lip, comprising:
a third circumferential sealing edge, directed radially inward and arranged to lie on the centrifugal disc; and
a fourth circumferential sealing edge, directed axially outward and arranged to lie on the centrifugal disc.

12. The sealing arrangement of claim 11, wherein the sealing ring further comprises a circumferential wiper lip, directed radially inward and arranged axially inside of the first circumferential sealing lip.

13. The sealing arrangement of claim 11, further comprising a first guide ring, wherein:
the first circumferential sealing lip comprises a first circumferential guide ring receptacle, directed radially inward and arranged radially outside of the first circumferential sealing edge;
the first guide ring is seated in the first circumferential guide ring receptacle; and
the first guide ring presses the first circumferential sealing edge radially inward and presses the second circumferential sealing edge axially outward.

14. The sealing arrangement of claim 13, wherein the first guide ring comprises an elastic material.

15. The sealing arrangement of claim 13, wherein a cross-section through the first guide ring has a circular ring shape in a plane comprising the axis of rotation.

16. The sealing arrangement of claim 13, further comprising a second guide ring, wherein:
the second circumferential sealing lip comprises a second circumferential guide ring receptacle, directed radially inward and arranged radially outside of the second circumferential sealing edge;
the second guide ring is seated in the second circumferential guide ring receptacle; and
the second guide ring presses the third circumferential sealing edge radially inward and presses the fourth circumferential sealing edge axially outward.

17. The sealing arrangement of claim 16, wherein the first guide ring and the second guide ring each comprise an elastic material.

18. The sealing arrangement of claim 16, wherein:
a cross-section through the first guide ring has a circular ring shape in a plane comprising the axis of rotation; and
the second guide ring has a circular ring shape cross-section in a plane comprising the axis of rotation.

19. The sealing arrangement of claim 11, further comprising a second guide ring, wherein:
the second circumferential sealing lip comprises a second circumferential guide ring receptacle, directed radially inward and arranged radially outside of the second circumferential sealing edge;
the second guide ring is seated in the second circumferential guide ring receptacle; and
the second guide ring presses the third circumferential sealing edge radially inward and presses the fourth circumferential sealing edge axially outward.

20. The sealing arrangement of claim 19, wherein the second guide ring comprises an elastic material.

21. The sealing arrangement of claim 19, wherein a cross-section through the second guide ring has a circular ring shape in a plane comprising the axis of rotation.

22. The sealing arrangement of claim 11, wherein:
the first circumferential sealing lip lies on a first L-profile-shaped circumferential section of the centrifugal disc; and
the second circumferential sealing lip lies on a second L-profile-shaped circumferential section of the centrifugal disc.

23. The sealing arrangement of claim 22, wherein the second L-profile-shaped circumferential section is arranged radially outside of the first L-profile-shaped circumferential section.

24. An arrangement comprising:
a first machine element;
a second machine element, rotatable relative to the first machine element about an axis of rotation; and
the sealing arrangement of claim 11 arranged for sealing off a space between the first machine element and the second machine element.

25. The arrangement of claim 24, wherein:
the arrangement is a rolling bearing;
the first machine element is an outer ring of the rolling bearing;
the second machine element is an inner ring of the rolling bearing; and
the space between the first machine element and the second machine element is a rolling element space of the rolling bearing which is used to receive rolling elements.

26. The arrangement of claim 25 further comprising the rolling elements arranged radially between the outer ring and the inner ring.
